(19) United States
(12) Patent Application Publication
(10) Pub. No.: US 2026/0011760 A1
(43) Pub. Date: Jan. 8, 2026

(54) SYSTEMS AND METHODS OF USING PURE HYDROGEN AS FUEL IN A TURBOCHARGED FUEL CELL

(71) Applicant: Caterpillar Inc., Peoria, IL (US)

(72) Inventors: David Andrew Pierpont, Dunlap, IL (US); Sachin S. Deshmukh, Dunlap, IL (US)

(73) Assignee: Caterpillar Inc., Peoria, IL (US)

(21) Appl. No.: 18/761,528

(22) Filed: Jul. 2, 2024

(51) Int. Cl. H01M 8/04746; H01M 8/04014; H01M 8/04089; H01M 8/04225

(52) U.S. Cl. CPC H01M 8/04753; H01M 8/04014; H01M 8/04097; H01M 8/04225; H01M 2220/20

(57) ABSTRACT

Provided herein are systems and methods for using pure hydrogen as fuel in a turbocharged fuel cell. A vehicle may include a storage configured to store pressurized hydrogen, a fuel cell, a catalytic converter, and a turbo compressor. The fuel cell includes an anode loop fluidically coupled to the storage and configured to receive the pressurized hydrogen therefrom, and a cathode loop configured to receive oxygen. The catalytic converter, arranged downstream from the anode loop, recovers excess hydrogen from the pressurized hydrogen used by the anode loop and recovers excess oxygen from the oxygen used by the cathode loop. The turbo compressor includes an expander to recover heat from the catalytic converter.

### TECHNICAL FIELD

The present implementations relate generally to fuel cells and more particularly to systems and methods of turbocharging fuel cells using hydrogen.

### BACKGROUND

The present disclosure relates generally to fuel cell systems, and more particularly to high-efficiency turbocharged fuel cells using pure hydrogen as fuel. In some implementations, various fuel cell systems, and particularly high-temperature fuel cell systems, may operate at a lower efficiency as compared to other fuel cell systems, such as low-temperature fuel cell systems. Therefore, it may be beneficial to increase the efficiency of a high-temperature fuel cell system.

For example, U.S. Pat. No. 10,930,948 describes a system and method for a fuel cell system including a fuel cell configured to be supplied with an anode gas and a cathode gas and generate electric power, a compressor configured to supply the cathode gas to the fuel cell, a turbine configured to be supplied with a cathode discharged gas discharged from the fuel cell and generate power, an electric motor connected to the compressor and the turbine and configured to perform power running and regeneration, a combustor disposed between the fuel cell and the turbine and configured to mix and combust the cathode gas and the anode gas, a cooler configured to cool the cathode gas that is supplied from the compressor to the fuel cell, a bypass passage configured to supply the cathode gas from an upstream side of the cooler to the combustor by bypassing the cooler and the fuel cell, and a bypass valve disposed in the bypass passage.

### SUMMARY

A first aspect provided herein relates to a vehicle. The vehicle may include storage capable of storing pressurized hydrogen. The vehicle may include a fuel cell comprising an anode loop fluidically coupled to the storage and configured to receive the pressurized hydrogen therefrom and a cathode loop configured to receive oxygen. The vehicle may include a catalytic converter arranged downstream from the anode loop. The catalytic converter may be configured to recover excess hydrogen from the pressurized hydrogen used by the anode loop and recover excess oxygen from the oxygen used by the cathode loop. The vehicle may include a turbo compressor comprising an expander. The catalytic converter may be configured to supply heat to the expander of the turbo compressor.

A second aspect provided herein relates to an energy system. The energy system may include storage capable of storing pressurized hydrogen. The energy system may include a fuel cell comprising an anode loop fluidically coupled to the storage and configured to receive the pressurized hydrogen therefrom and a cathode loop configured to receive oxygen. The energy system may include a catalytic converter arranged downstream from the anode loop. The catalytic converter may be configured to recover excess hydrogen from the pressurized hydrogen used by the anode loop and recover excess oxygen from the oxygen used by the cathode loop. The energy system may include a turbo compressor comprising an expander. The catalytic converter may be configured to supply heat to the expander of the turbo compressor.

A third aspect provided herein relates to a method. The method may include receiving, by an anode loop, pressurized hydrogen. The method may include receiving, by a cathode loop, oxygen. The method may include recovering, by a catalytic converter arranged downstream from the anode loop, excess hydrogen from the pressurized hydrogen used by the anode loop and excess oxygen from the oxygen used by the cathode loop. The method may include supplying, by the catalytic converter, heat to an expander of a turbo compressor.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for increasing efficiency and power density of fuel cells, in accordance with present implementations;

FIG. 2 is a schematic diagram of anode and cathode loops of a fuel cell system, in accordance with present implementations;

FIG. 3 is a schematic diagram of coolant and high voltage loops of a fuel cell system, in accordance with present implementations;

FIG. 4 is a schematic diagram of anode and cathode loops of a fuel cell system, in accordance with present implementations;

FIG. 5 is a schematic diagram of coolant and high voltage loops of a fuel cell system, in accordance with present implementations;

FIGS. 6A and 6B are schematic diagrams of anode and cathode loops of a fuel cell system, in accordance with present implementations;

FIG. 7 is a schematic diagram of coolant and high voltage loops of a fuel cell system, in accordance with present implementations;

FIG. 8 is a flowchart showing a method of increasing efficiency and power density of fuel cells, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to implement high-efficiency turbocharged fuel cells using pure hydrogen fuel. For example, a system may include a storage source capable of storing or providing pressurized hydrogen. The system may include at least one fuel cell having an anode loop and a cathode loop. The anode loop may receive pressurized hydrogen from the hydrogen source and the cathode loop may receive oxygen. The system may include a catalytic converter arranged downstream from the anode loop and/or from the cathode loop. The catalytic converter may recover at least some of the excess hydrogen from the pressurized hydrogen used by the anode loop and at least some of the excess oxygen from the oxygen used by the cathode loop. The system may include a turbo compressor having an expander which may recover heat from the catalytic converter. In some implementations, the system may additionally or alternatively include at least one bypass valve to facilitate managing surge and/or an air-to-fuel ratio for the catalytic converter. The system may additionally or alternatively include at least one heat exchanger capable of providing heat to a coolant circuit of the system. The system may additionally or alternatively include at least one recirculation blower to facilitate providing diluted hydrogen back to an intake of the anode loop. Such configurations allow the system to operate at a maximum efficiency and power output.

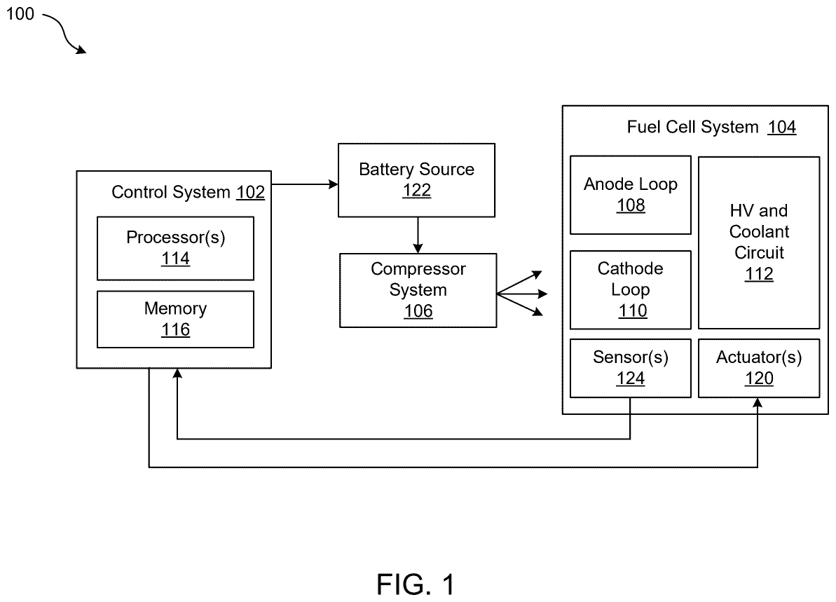

Referring now to FIG. 1, depicted is a block diagram of a system 100 for high-efficiency turbocharging of, for example, high temperature proton exchange membrane (HT-PEM) fuel cells using hydrogen fuel, according to an example implementation of the present disclosure. The system 100 may include a control system 102 communicably coupled to a fuel cell system 104 and a compressor system 106. The system 100 may be implemented in various environments or systems. For example, the system 100 may be implemented in various vehicles for supplying power to the vehicle, as a power generation system for homes or businesses (e.g., primary or back-up power), etc. In some embodiments, the system 100 may be implemented in various heavy machinery components or vehicles to supply power thereto. As described in greater detail herein, the control system 102 may be configured to control the fuel cell system 104 and the compressor system 106 to recover excess hydrogen and oxygen from the fuel cell system 104 using a turbocharger of the compressor system 106 to increase the efficiency and power density of the fuel cell system 104.

The fuel cell system 104 may include various types or forms of fuel cells. In some embodiments, the fuel cell system 104 may be or include a proton exchange membrane (PEM) fuel cell. For example, the fuel cell system 104 may be or include a high temperature PEM (HT-PEM) fuel cell (e.g., a fuel cell which operates at high temperatures at fully warm conditions, such as 160° C. to 200° C.) or a low temperature PEM (LT-PEM) fuel cell (e.g., a fuel cell which operates at low temperatures [relative to HT-PEM fuel cells] at fully warm conditions, such as 70° C.). In various embodiments, the fuel cell system 104 may include other types of fuel cells, such as solid oxide fuel cells (SOFCs), molten carbonate fuel cells (MCFCs), alkaline fuel cells (AFCs), phosphoric acid fuel cells (PAFCs), and/or direct methanol fuel cells (DMFCs).

The fuel cell system 104 may include an anode loop 108, a cathode loop 110, and a high voltage (HV) and coolant circuit 112. As described in greater detail herein, the anode loop 108 may be configured to be supplied with hydrogen. The cathode loop 110 may be configured to be supplied with oxygen. The anode loop 108 and cathode loop 110 may supply the hydrogen and oxygen to a PEM, which converts the hydrogen into protons and electrons, the protons interacting with the oxygen for producing heat and water, and the electrons supplied as power.

The control system 102 may include one or more processors 114 and memory 116. The processor(s) 114 may be or include any device, component, element, or hardware designed or configured to perform the various steps recited herein. For example, the processor(s) 114 may include any number of general purpose single-or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the control system 102 may include a single processor 114 designed or configured to perform each of the various steps recited herein. In some embodiments, the control system 102 may include multiple processors 114 which are designed or configured perform (e.g., either separately or together) each of the various steps recited herein. As one example, the control system 102 may include a first processor 114 designed or configured to perform a first subset of the various steps, and a second processor 114 designed or configured to perform a second subset of the various steps (with the first subset being different from the second subset). As another example, the control system 102 may include first and second processors 114 which together perform the various steps in a distributed fashion. As such, unless explicitly indicated otherwise, such as by use of a term such as “a single processor,” the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. The memory 116 may be or include any type or form of data storage device, including tangible, non-transient volatile memory and/or non-volatile memory.

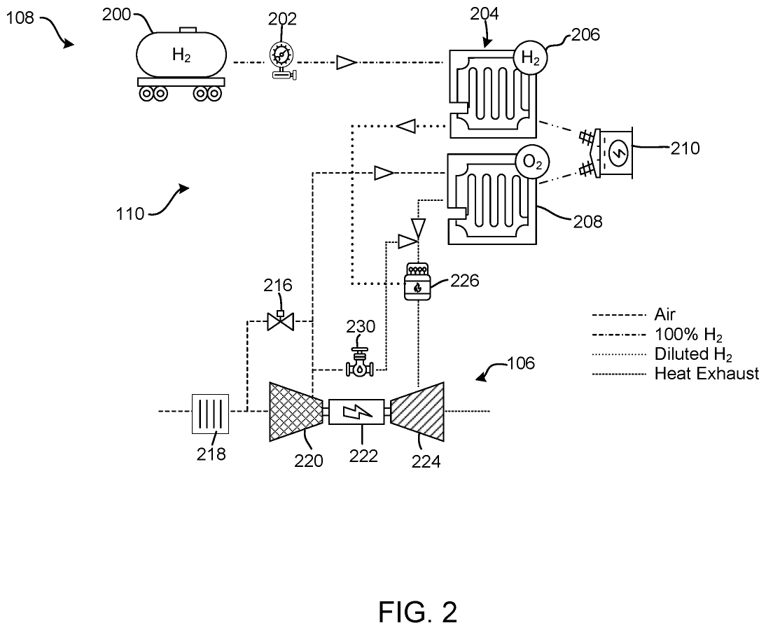

Referring now to FIG. 1 and FIG. 2, the fuel cell system 104 may include the anode loop 108 and the cathode loop 110. Specifically, FIG. 2 is a schematic diagram of the anode and cathode loops 108, 110 of the fuel cell system 104, according to an implementation of the present disclosure. As shown in FIG. 2, the anode loop 108 may include a hydrogen storage source 200 fluidically coupled to the anode loop 108. The hydrogen storage source 200 may be communicably and/or fluidically coupled to a pressure regulator 202. The pressure regulator 202 may be disposed between the hydrogen source 200 and the anode loop 108. The hydrogen source 200 may be configured to supply or otherwise provide hydrogen (e.g., H₂) to the pressure regulator 202. The pressure regulator 202 may be configured to increase, decrease, or otherwise regulate the supplied hydrogen from the hydrogen source 200 for supplying hydrogen to a proton exchange membrane (PEM) 204. The hydrogen source 200 may be configured to store pressurized hydrogen and/or the pressure regulator 202 may be configured to pressurize the hydrogen from the hydrogen source 200 to provide pressurized hydrogen to the PEM 204. Specifically, the pressure regulator 202 may be configured to supply the pressurized hydrogen to an anode catalyst 206 of the PEM 204.

The cathode loop 110 may have air (e.g., ambient air) supplied thereto. Specifically, oxygen from the ambient air may be supplied to a cathode catalyst 208 of the PEM 204. The cathode loop 110 may include an air filter 218 arranged at an inlet to the cathode loop 110, to filter air prior to entering the cathode loop 110. For example, in some implementations, the ambient air may be fed through the filter 218 and/or a compressor 220 prior to being supplied to the cathode catalyst 208 to filter the air and increase the pressure and/or temperature of the air prior to the cathode loop 110. Together, the hydrogen supplied to the anode catalyst 206 and the oxygen supplied to the cathode catalyst 208 may operate to produce electrical energy and heat for the fuel cell. More specifically, the hydrogen may be split into protons and electrons at the anode catalyst 206, and the oxygen may combine with the protons and electrons to produce electricity and water, with heat generated as a byproduct. The electrons may flow to an electrical power circuit 210 (e.g., a high-voltage bus) to generate electrical power, while the protons may move through the PEM 204 to facilitate the electrochemical reactions for producing the water and heat.

The fuel cell system 104 may include a catalytic converter 226 communicably coupled to the anode catalyst 206 and/or the cathode catalyst 208. The catalytic converter 226 may be arranged downstream from the anode loop 108 and/or from the cathode loop 110. The catalytic converter 226 may be configured to at least partially recover excess hydrogen from the pressurized hydrogen used by the anode loop 108. Specifically, the catalytic converter 226 may be fed diluted excess hydrogen not used in the anode loop 108 by the anode catalyst 206. Similarly, the catalytic converter 226 may be configured to at least partially recover excess oxygen in the form of heat exhaust (e.g., warm air or steam) from the oxygen used by the cathode loop 110. Specifically, the catalytic converter 226 may be fed oxygen not used in the cathode loop 110 by the cathode catalyst 208. In some implementations, the temperature of the excess oxygen out of the cathode loop 110 may be between 160° C. to 200° C. The excess hydrogen from the anode loop 108 may be configured to combine with the excess oxygen from the cathode loop 110 and routed through the catalytic converter 226 to release hydrogen energy and increase the heat exhaust temperature through the fuel cell system 104. For example, in some implementations, the temperature of the excess heat exhaust (e.g., warm air or steam) out of the catalytic converter 226 may be between 200° C. to 300° C. The high-pressure and high-temperature heat exhaust from the catalytic converter 226 may then be fed to an expander 224 of the compressor system 106 to extract, for example, work from the heat exhaust.

For example, in various embodiments, the compressor system 106 may be or include a turbo compressor system 106. The compressor system 106 may be communicably coupled to the control system 102 and powered by a battery source 122. In this regard, the compressor system 106 may be or include an eTurbo (e.g., an electric turbo) compressor system 106. The battery source 122 may be an external battery source separate from the electrical power circuit 210. In some embodiments, the battery source 122 may be charged by or using electrical power of the electrical power circuit 210. As shown in FIG. 2, the compressor system 106 may include a compressor 220, a turbocharger 222, and an expander 224. The compressor 220 may receive air as an input (e.g., downstream from the filter 218), and compress the air to supply pressurized, and correspondingly heated, air to the cathode catalyst 208.

The turbocharger 222 may be configured to use or leverage energy from the flow of exhaust gases (e.g., the heat exhaust described herein) from the system 100 to drive the compressor 220 (e.g., alone or together with the battery source 122). For example, the expander 224 may be configured to recover some of the energy from the pressurized heat exhaust. Specifically, the expander 224 may be communicably coupled to the catalytic converter 226 and may be configured to recover the heat exhaust supplied from the catalytic converter 226. For example, as described herein, the catalytic converter 226 is configured to increase the temperature of heat exhaust resulting as a byproduct from the cathode loop 110 to increase the amount of heat recoverable by the expander 224. In other words, the catalytic converter 226 may be configured to supply re-heated heat exhaust (e.g., air or steam) to the expander 224 to extract mechanical energy to at least partially operate, for example, the compressor 220, or for another application. Such implementation allows for the fuel cell system 104 to operate with a maximum efficiency as compared to conventional techniques while minimizing manufacturing efforts and costs for the system 100.

The fuel cell system 104 may include various actuators 120. The actuators 120 may include pumps, valves, regulators, diverters, or any other actuators designed or configured to control the flow of a fluid. For instance, the cathode loop 110 may include various actuators 120 for regulating the flow of air to or from the cathode catalyst 208. For example, the cathode loop 110 may include at least one recirculation valve 216 for selectively recirculating air back to the compressor 220. As shown in FIG. 2, and in some embodiments, the cathode loop 110 may include a recirculation valve 216 arranged downstream of the compressor to supply heated air (e.g., pressurized oxygen) from the compressor 220 (e.g., output by the compressor 220) back to an input of the compressor 220. In such an example, at least a portion of the heated air may be heated twice, then re-output by the compressor 220 towards the cathode catalyst 208, thereby increasing the temperature and/or pressure of the fuel cell system 104 faster.

Similarly, the anode loop 108 may include various actuators 120 for controlling the flow of hydrogen to the anode catalyst 206. For example, the cathode loop 110 may include the pressure regulator 202. Additionally, the HV and coolant circuit 112 may include various actuators 120 for controlling the flow of coolant. For example, the HV and coolant circuit 112 may include various pumps 300 and a sensor (e.g., a thermostat) 124 with an included actuator for controlling the flow of coolant through the coolant circuit 112.

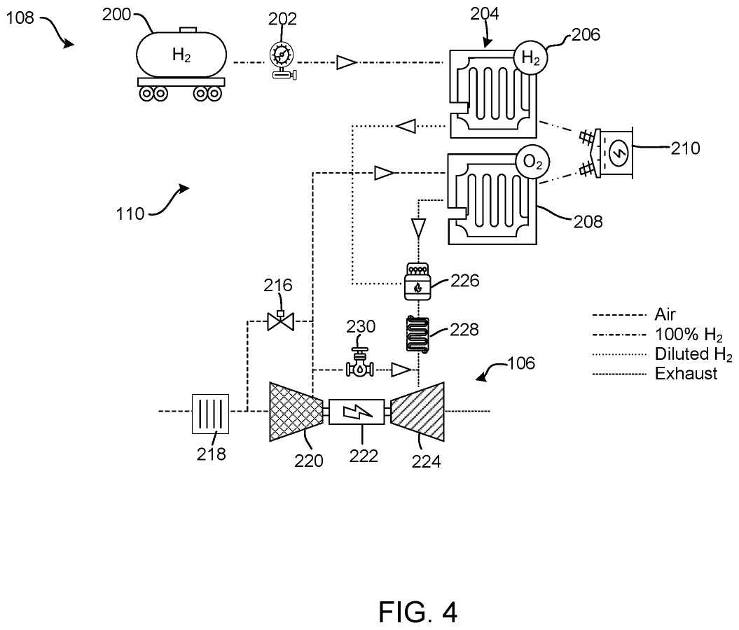

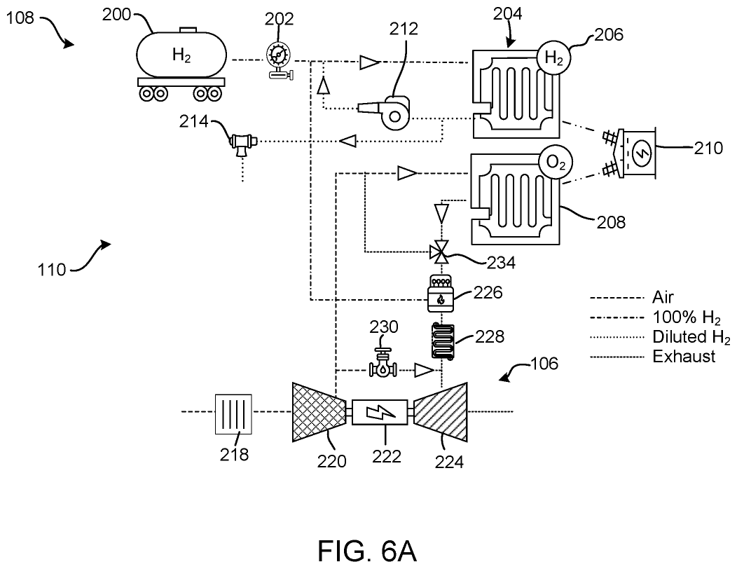

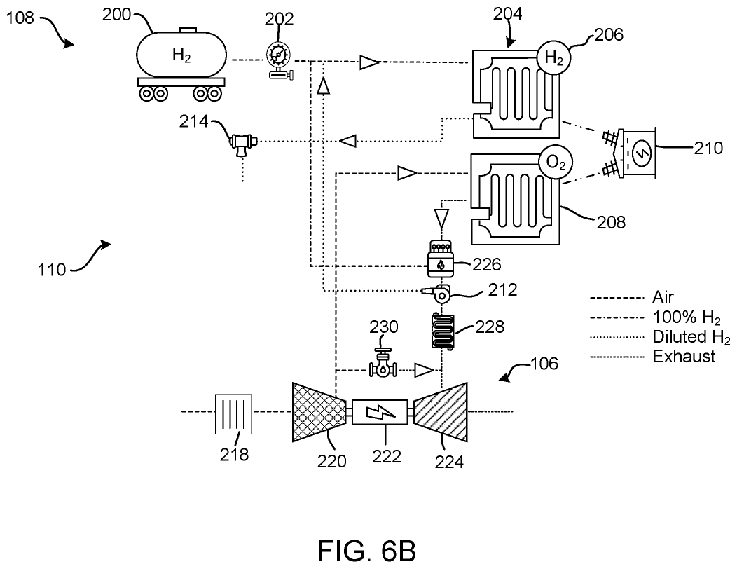

The cathode loop 110 may include a bypass valve 230 to divert air that may be fed from the compressor 220 to the cathode catalyst 208 to instead be fed into the catalytic converter 226. For example, the bypass valve 230 may be arranged downstream from the compressor 220. The bypass valve 230 may be configured to selectively supply pressurized oxygen from the compressor 220 to the catalytic converter 226. Such implementation may facilitate managing surge and hydrogen catalyst to control the air-fuel ratio in the catalytic converter 226. In some implementations, as depicted in FIGS. 4 and 6A and 6B, the bypass valve 230 may be configured to divert air that may be fed from the compressor 220 to the cathode catalyst 208 to instead be fed into the expander 224. For example, the bypass valve 230 may be configured to selectively supply pressurized oxygen from the compressor 220 to the expander 224 to provide heated air to the expander 224.

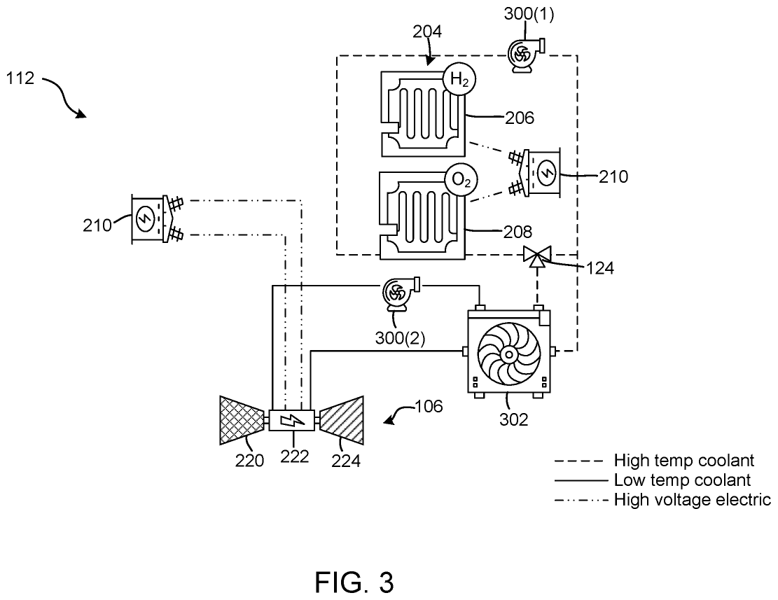

Referring now to FIG. 1 and FIG. 3, the fuel cell system 104 may include the HV and coolant circuit 112. More specifically, FIG. 3 is a schematic diagram of the HV and coolant circuits 112 of the fuel cell system 104, according to an embodiment of the present disclosure. The coolant circuit 112 may include various pumps 300 for pumping coolant through the coolant circuit 112. For example, a first pump 300(1) may pump high temperature coolant through the PEM 204, and a second pump 300(2) may pump low temperature coolant from the compressor 220 and/or compressor system 106 through the coolant circuit 112. The coolant circuit 112 may include a heat exchanger 302. The heat exchanger 302 may be configured to transfer absorbed heat from the coolant to an external fluid (e.g., air or some other cooling medium) to dissipate heat, and/or preheat incoming coolant. The coolant circuit 112 may include one or more sensor(s) 124 arranged to measure, detect, or otherwise quantify a temperature of coolant of the coolant circuit 112. In some embodiments, the sensor(s) 124 may be or include temperature sensors arranged to measure the temperature of the coolant. For example, the sensor(s) 124 may be a thermostat, which may include a valve for controlling the flow of coolant to the heat exchanger 302.

As shown in FIG. 2 and FIG. 3, the compressor 220 may be arranged to supply compressed (and thus heated) air to the coolant circuit 112. Specifically, as shown in FIG. 2, the compressor 220 may supply compressed and heated air to the cathode catalyst 208 of the PEM 204 (e.g., the air side of the stack of the PEM 204), and as shown in FIG. 3, the high temperature coolant may pump through the cathode catalyst 208. In this regard, by supplying pressurized heated air to the cathode catalyst 208, the compressor 220 is arranged to also supply pressurized heated air to the coolant circuit 112.

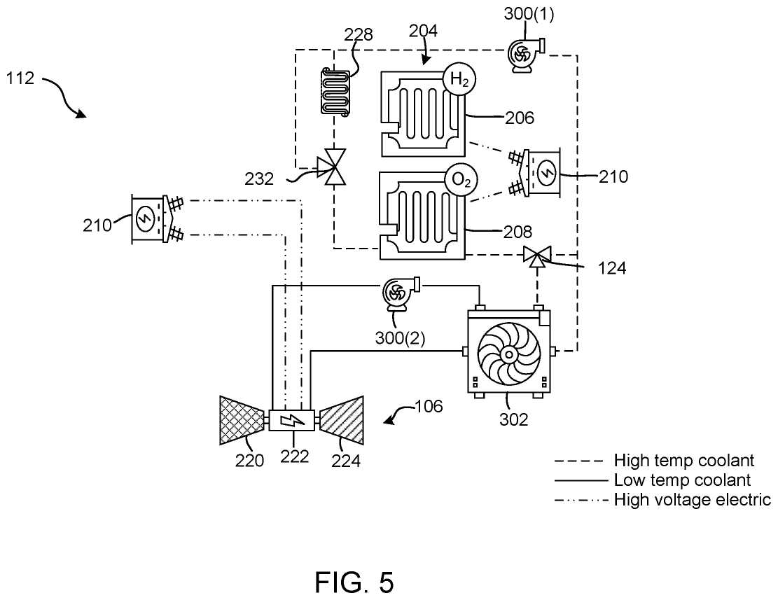

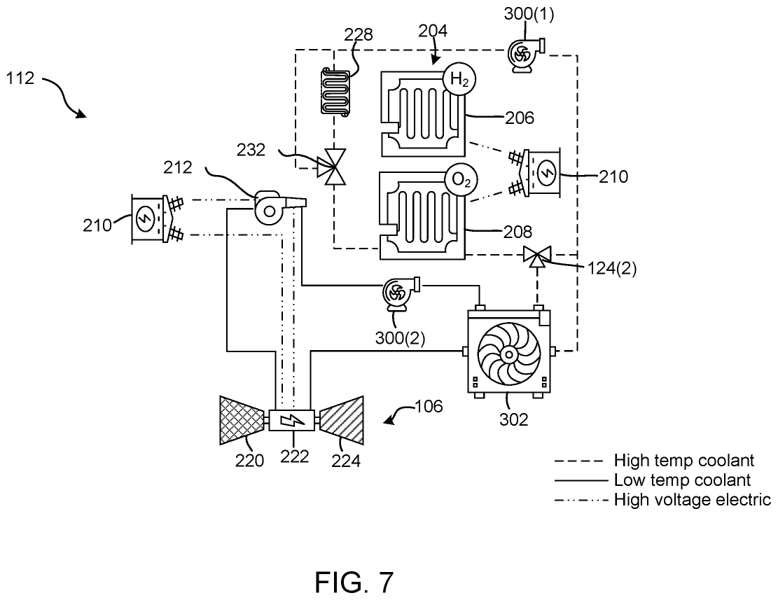

In various embodiments, the catalytic converter 226 may be configured to supply heat to the coolant circuit 112. In some implementations, the catalytic converter 226 may be configured to supply heat to the coolant circuit 112 through a heat exchanger. For example, in some implementations, the fuel cell system 104 may include a heat exchanger 228 as shown in FIGS. 4-7. Specifically, the heat exchanger 228 may be arranged downstream of the catalytic converter 226. The heat exchanger 228 may be configured to facilitate fast-warm up by transferring heat from the catalytic converter 226 to the coolant of the coolant circuit 112, as depicted in FIGS. 5 and 7. The coolant circuit 112 may include at least one bypass valve 232. The bypass valve 232 may be configured to selectively cause the coolant flow through the coolant circuit 112 to flow through the heat exchanger 228 or bypass the heat exchanger 228. For example, in some implementations, the control system 102 may be configured to activate the bypass valve 232 based on, for example, a temperature reading of the coolant by a sensor (e.g., thermostat) 124. Excess heat exhaust from the heat exchanger 228 may be configured to be fed to the expander 224 to increase efficiency. In some implementations, the coolant circuit 112 may include a recirculation blower 212, as depicted in FIG. 7.

In some implementations, the catalytic converter 226 may be configured to supply heat to the coolant circuit 112 during a warm-up condition of the fuel cell system 104. For example, the control system 102 may be configured to detect, determine, or otherwise identify a warm-up condition of the fuel cell system 104. In some embodiments, the control system 102 may be configured to identify the warm-up condition of the fuel cell system 104 based on data from a timer. For example, the control system 102 may measure a duration or time from a previous run-time of the fuel cell system 104. The control system 102 may identify the warm-up condition responsive to the measured duration satisfying a threshold (e.g., being greater than or equal to a duration corresponding to the warm-up condition). The threshold may be set based on the particular fuel cell system 104, an estimated time in which heat of the fuel cell system 104 naturally dissipates, etc. In some embodiments, the control system 102 may be configured to identify the warm-up condition of the fuel cell system 104 based on data from a sensor 124. For example, the control system 102 may be configured to identify the warm-up condition of the fuel cell system 104 responsive to a temperature of coolant of the HV and coolant circuit 112 satisfying a threshold (e.g., being less than or equal to a threshold temperature of coolant for operating the fuel cell system 104 for producing power).

In some implementations, the control system 102 may be configured to activate the compressor system 106 to supply compressed heated air to the coolant circuit 112 during the warm-up condition. The control system 102 may be configured to activate the compressor system 106 responsive to identifying the warm-up condition. In some embodiments, the control system 102 may activate the compressor system 106 by sending a signal to the battery source 122 to supply power to the compressor system 106. In some embodiments, the control system 102 may activate the compressor system 106 to run at a high speed and high pressure ratio, to compress and heat air supplied to the cathode loop 110. The compressor 220 may be configured to heat the air to high temperature (up to 200° C.) at, e.g., maximum compressor system 106 speed (when the turbocharger 222 and battery source 122 are driving the compressor system 106 at maximum speed or output). The compressor 220 may be arranged or configured to supply the high pressure and temperature air through the fuel cell stack (e.g., the cathode catalyst 208) to warm up the stack itself and the coolant circuit 112. The compressor 220 may be arranged to supply the high pressure and temperature air through the cathode loop 110 (O₂/air side) of the fuel cell stack (e.g., the PEM 204) and transfer heat to the stack (e.g., the cathode catalyst 208) and coolant circuit 112.

In some implementations, the control system 102 may be configured to operate the pumps 300 to circulate coolant through the coolant circuit 112. The control system 102 may also control the sensor 124 to bypass flow to the heat exchanger 302. For example, the control system 102 may circulate coolant through the coolant circuit 112 while bypassing the heat exchanger 302 while the warm-up condition is present. As the coolant circulates through the coolant circuit 112, the compressed and heated air may heat up the coolant. The control system 102 may be configured to monitor (e.g., via the sensor data from the sensor(s) 124) the temperature of the coolant as the coolant is heated by the compressor 220. Once the coolant (and stack of the fuel cell system 104) reach a temperature which satisfies a threshold criteria (e.g., a minimum startup temperature in which the fuel cell system 104 can generate power and heat), the control system 102 may be configured to control the sensor 124 to permit flow of the coolant to the heat exchanger 302. In this regard, the fuel cell power and compressor system 106 power may be managed during the warm-up period, to thereby optimize power usage and consumption during warm-up.

In some implementations, the fuel cell system 104 may include at least one a hydrogen recirculation blower 212. As depicted in FIG. 6A, the hydrogen recirculation blower 212 may be arranged downstream of the anode catalyst 206 to recover excess hydrogen (e.g., diluted hydrogen) not used by the anode catalyst 206. The hydrogen recirculation blower 212 may be configured to pump the excess hydrogen back into the input of the anode catalyst 206 to increase the efficiency of the anode loop 108. As depicted in FIG. 6B, a hydrogen recirculation blower 212 may optionally be provided and arranged downstream from the catalytic converter 226 and/or upstream of the heat exchanger 228. The hydrogen recirculation blower 212 may be configured to supply at least some of any excess hydrogen used by the catalytic converter 226 to the anode loop 108. For example, the hydrogen recirculation blower 212 may be configured to pump excess hydrogen from the catalytic converter 226 back into the input of the anode catalyst 206 to increase the efficiency of the anode loop 108.

In some implementations, the fuel cell system 104 may include at least one flow control valve 234, as depicted in FIG. 6A. The flow control valve 234 may be configured to selectively cause recovered oxygen from the cathode loop 110 to flow through the catalytic converter 226 or to supply the recovered oxygen back to the cathode loop 110 as an input to the cathode catalyst 208 to regulate the recovered oxygen from the cathode loop 110. For example, in some implementations, the control system 102 may be configured to activate the flow control valve 234 based on, for example, a sensor reading of an amount of hydrogen or oxygen being fed to the catalytic converter 226 and/or a sensor reading of an amount of oxygen being fed to the cathode catalyst 208.

In some implementations, the fuel cell system 104 may include at least one purge valve 214. The purge valve 214 may be fluidically coupled to and arranged downstream of the anode catalyst 206. The purge valve 214 may be configured to modify the pressure of the excess hydrogen from the anode loop 108 and/or remove excess hydrogen from the anode loop 108. For example, the purge valve 214 may open and close, to throttle the diluted hydrogen flow to maintain stable pressure within the anode loop 108 (e.g., by ensuring that the pressure is neither too high, which can cause mechanical stress, nor too low, which can reduce efficiency of the system).

### INDUSTRIAL APPLICABILITY

The disclosed embodiments may be applicable to any fuel cell-based system or solution. For example, the disclosed embodiments may be applicable to or applied to a vehicle, such as an automobile, heavy machinery, or any other type of vehicle, a power source for a home, office, or any other residential/industrial setting, or any other power delivery system which may be powered by a fuel cell. The disclosed embodiments may be applicable to fuel cell-based systems which use or include HT-PEM fuel cells, or fuel cells which are designed to operate at high temperatures.

The disclosed embodiments may be used to improve efficiency and power density of the system 100 by increasing the pressure and/or temperature of the anode and cathode loops 108, 110 of the fuel cell system 104 and recovering some of the exhaust heat energy of the fuel cell system 104 through the expander 224 of the turbocharger 222. For example, the compressor 220 and the expander 224 of a turbocharger 222 may be used to achieve the elevated pressures and/or temperatures and to recover some of the heat exhaust energy. Moreover, in some implementations, excess hydrogen from the anode loop 108 of the fuel cell system 104 may combine with excess oxygen from the cathode loop 110 of the fuel cell system 104 and routed through the catalytic converter 226 to release hydrogen energy and increase the exhaust temperature. Heat exhaust from the catalytic converter 226 may be recovered by the expander 224. Increasing the pressure and recovering some of the exhaust heat energy in such configurations significantly increases system efficiency and power output of the fuel cell system 104.

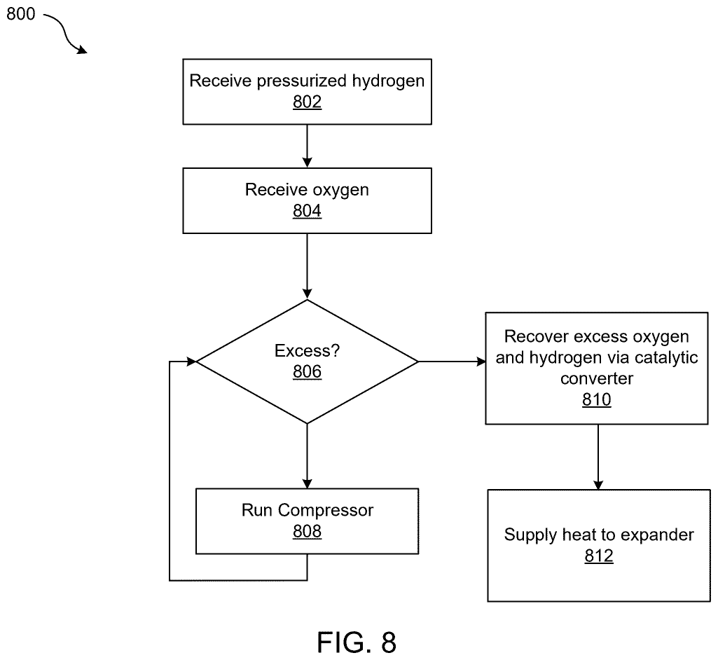

Referring now to FIG. 8, depicted is a flowchart showing an example method 800 of efficiently turbocharging HT-PEM fuel cells using hydrogen, according to an example implementation of the present disclosure. The method 800 may be performed by, implemented on, or otherwise executed by the components, elements, or hardware described above with reference to FIG. 1 through FIG. 7. For example, the method 800 may be executed by the system 100 (e.g., by the fuel cell system 104, the control system 102, and/or compressor system 106) of FIG. 1. As a brief overview, at step 802, the system 100 may receive, via the anode loop 108, pressurized hydrogen. At step 804, the system 100 may receive, via the cathode loop 110, oxygen. At step 806, the system 100 may determine whether there is excess hydrogen or oxygen. At step 808, the system 100 may run the compressor 220. At step 810, the system 100 may recover the excess oxygen and hydrogen via the catalytic converter 226. At step 812, the system 100 may supply heat to the expander 224.

At step 802, the system 100 (e.g., the fuel cell system 104) may receive, via the anode loop 108, pressurized hydrogen. For example, the anode loop 108 may include a hydrogen storage source 200 communicably coupled to a pressure regulator 202. The hydrogen source 200 may supply or otherwise provide hydrogen (e.g., H₂) to the pressure regulator 202. The pressure regulator 202 may increase, decrease, or otherwise regulate the supplied hydrogen from the hydrogen source 200, for supply to a proton exchange membrane (PEM) 204. The hydrogen source 200 may store pressurized hydrogen and/or the pressure regulator 202 may pressurize the hydrogen from the hydrogen source 200 to provide pressurized hydrogen. Specifically, the pressure regulator 202 may supply the pressurized hydrogen to an anode catalyst 206 of the PEM 204 for the anode loop 108.

At step 804, the system 100 (e.g., the fuel cell system 104) may receive, via the cathode loop 110, oxygen. For example, oxygen from the ambient air may be supplied to a cathode catalyst 208 of the PEM 204. In some implementations, the ambient air may be fed through the filter 218 and/or the compressor 220 prior to being supplied to the cathode catalyst 208 to filter the air and increase the pressure and/or temperature of the air prior to the cathode loop 110. Together, the hydrogen supplied to the anode catalyst 206 and oxygen supplied to the cathode catalyst 208 may operate to produce electrical energy and heat for the fuel cell. More specifically, the hydrogen may be split into protons and electrons at the anode catalyst 206, and the oxygen may combine with the protons and electrons to produce electricity and water, with heat generated as a byproduct. The electrons may flow to an electrical power circuit 210 (e.g., a high-voltage bus) to generate electrical power, while the protons may move through the PEM 204 to facilitate the electrochemical reactions for producing the water and heat.

At step 806, the system 100 (e.g., the control system 102) may determine whether there is excess hydrogen or oxygen from the anode loop 108 and/or the cathode loop 110 based on the fuel cell system 104. For example, in some implementations, the control system 102 may determine there is excess hydrogen or oxygen based on a starting condition (e.g., the hydrogen source 200 starting to provide hydrogen, the cathode catalyst 208 starting to receive oxygen, etc.). In some implementations, the control system 102 may determine there is excess hydrogen or oxygen based on a predetermined period of time passing (e.g., the hydrogen source 200 providing hydrogen for a predetermined period of time, the cathode catalyst 208 receiving oxygen for a predetermined period of time, etc.). In some implementations, the control system 102 may determine there is excess hydrogen or oxygen in various other ways including, but not limited to, a user input, a sensor input, or various other ways.

Where, at step 806, the system 100 determines there is no excess hydrogen or oxygen, the method 800 may continue to step 808 where the control system 102 runs the compressor 220. In this regard, the control system 102 may operate the compressor 220 to supply compressed heated air to the coolant circuit 112 and stack of the fuel cell system 104 and/or to the cathode loop 110 of the fuel cell system 104.

Where, at step 806, the system 100 determines there is excess hydrogen or oxygen, the method 800 may continue to step 810 where the fuel cell system 104 feeds the excess hydrogen and/or oxygen into the catalytic converter 226 to recover the excess hydrogen and oxygen and increase the temperature of the heat exhaust from the cathode loop 110 (e.g., from a range of 160° C. to 200° C. to a range of 200° C. to 300° C.).

At step 812, the fuel cell system 104 may feed the heat from the catalytic converter 226 to the expander 224 of the compressor system 106 to recover the heat exhaust energy. In some implementations, the fuel cell system 104 may additionally or alternatively feed excess heat exhaust from the anode loop 108 and cathode loop 110 or from the catalytic converter 226 to the heat exchanger 228 to facilitate providing heat to coolant of the coolant circuit 112. In some implementations, the fuel cell system 104 may additionally or alternatively recirculate excess hydrogen from the anode loop 108 or from the catalytic converter 226 to the input of the anode catalyst 206 to facilitate increasing efficiency of the anode loop 108. In some implementations, the fuel cell system 104 may additionally or alternatively feed at least some of any excess hydrogen from the anode loop 108 to the purge valve 214 to facilitate discarding diluted hydrogen or maintaining an efficient level or pressure of the diluted hydrogen. In some implementations, the fuel cell system 104 may additionally or alternatively include at least one flow control valve 234 to selectively cause recovered oxygen from the cathode loop 110 to flow through the catalytic converter 226 or to supply the recovered oxygen back to the cathode loop 110 as an input to the cathode catalyst 208 to regulate the recovered oxygen from the cathode loop 110 based on, for example, a sensor reading of an amount of hydrogen or oxygen being fed to the catalytic converter 226 and/or a sensor reading of an amount of oxygen being fed to the cathode catalyst 208.

Such implementations allow for the fuel cell system 104 to operate with a maximum efficiency as compared to conventional techniques using HT-PEM fuel cells while minimizing manufacturing efforts and costs for the system 100.

What is claimed is:

1. A vehicle, comprising:
storage configured to store pressurized hydrogen;
a fuel cell comprising an anode loop fluidically coupled to the storage and configured to receive the pressurized hydrogen therefrom and a cathode loop configured to receive oxygen;
a catalytic converter arranged downstream from the anode loop, the catalytic converter configured to recover excess hydrogen from the pressurized hydrogen used by the anode loop and recover excess oxygen from the oxygen used by the cathode loop; and
a turbo compressor comprising an expander;
wherein the catalytic converter supplies heat to the expander of the turbo compressor.

2. The vehicle of claim 1, further comprising a pressure regulator fluidically coupled between the storage and the anode loop of the fuel cell, the pressure regulator configured to regulate a pressure of the pressurized hydrogen for supplying to the anode loop.

3. The vehicle of claim 1, wherein the turbo compressor further comprises a compressor configured to supply pressurized oxygen to the cathode loop.

4. The vehicle of claim 3, further comprising a bypass valve arranged downstream from the compressor of the turbo compressor, the bypass valve configured to selectively supply pressurized oxygen to the catalytic converter.

5. The vehicle of claim 3, further comprising a recirculation valve arranged downstream from the compressor of the turbo compressor, the recirculation valve configured to supply pressurized oxygen from the compressor back to an intake of the compressor.

6. The vehicle of claim 1, wherein the catalytic converter is arranged to supply heat to a coolant circuit of the fuel cell during a warm-up condition of the fuel cell.

7. The vehicle of claim 6, further comprising a heat exchanger arranged downstream from the catalytic converter, wherein the catalytic converter is configured to supply heat via the heat exchanger to the coolant circuit of the fuel cell.

8. The vehicle of claim 1, further comprising a flow control valve arranged downstream from the cathode loop, the flow control valve configured to regulate the recovered oxygen from the cathode loop supplied to the catalytic converter.

9. The vehicle of claim 8, wherein the flow control valve is configured to supply the recovered oxygen to the catalytic converter or to the cathode loop.

10. An energy system for a vehicle, the energy system comprising:
storage configured to store pressurized hydrogen;
a fuel cell comprising an anode loop fluidically coupled to the storage and configured to receive the pressurized hydrogen therefrom and a cathode loop configured to receive oxygen;
a catalytic converter arranged downstream from the anode loop, the catalytic converter configured to recover excess hydrogen from the pressurized hydrogen used by the anode loop and recover excess oxygen from the oxygen used by the cathode loop; and
a turbo compressor comprising an expander;
wherein the catalytic converter supplies heat to the expander of the turbo compressor.

11. The energy system of claim 10, further comprising a pressure regulator fluidically coupled between the storage and the anode loop of the fuel cell, the pressure regulator configured to regulate a pressure of the pressurized hydrogen for supplying to the anode loop.

12. The energy system of claim 10, wherein the turbo compressor further comprises a compressor configured to supply pressurized oxygen to the cathode loop.

13. The energy system of claim 12, further comprising a bypass valve arranged downstream from the compressor of the turbo compressor, the bypass valve configured to selectively supply pressurized oxygen to the catalytic converter.

14. The energy system of claim 12, further comprising a recirculation valve arranged downstream from the compressor of the turbo compressor, the recirculation valve configured to supply pressurized oxygen from the compressor back to an intake of the compressor.

15. The energy system of claim 10, wherein the catalytic converter is arranged to supply heat to a coolant circuit of the fuel cell during a warm-up condition of the fuel cell.

16. The energy system of claim 10, further comprising a flow control valve arranged downstream from the cathode loop, the flow control valve configured to regulate the recovered oxygen from the cathode loop supplied to the catalytic converter.

17. The energy system of claim 16, wherein the flow control valve is configured to supply the recovered oxygen to the catalytic converter or to the cathode loop.

18. A method comprising:
receiving, by an anode loop, pressurized hydrogen;
receiving, by a cathode loop, oxygen;
recovering, by a catalytic converter arranged downstream from the anode loop, excess hydrogen from the pressurized hydrogen used by the anode loop and excess oxygen from the oxygen used by the cathode loop; and
supplying, by the catalytic converter, heat to an expander of a turbo compressor.

19. The method of claim 18, further comprising supplying pressurized oxygen, wherein a bypass valve is arranged to selectively control a flow of the pressurized oxygen to the cathode loop or to the catalytic converter.

20. The method of claim 18, further comprising supplying pressurized oxygen from a compressor of the turbo compressor back to an intake of the compressor.
